(19) United States
(12) Patent Application Publication
(10) Pub. No.: US 2026/0264593 A1
(43) Pub. Date: Sep. 10, 2026

(54) POP-UP TYPE HOLDER, AND ARMREST AND CONSOLE ASSEMBLY INCLUDING THE SAME

(71) Applicant: KOMOS CO., LTD., Hwaseong-si Gyeonggi-do (KR)

(72) Inventors: Hyeon Muk KIM, Seoul (KR); Dong Min KIM, Anyang-si Gyeonggi-do (KR); In Chul YOO, Hwaseong-si Gyeonggi-do (KR)

(73) Assignee: KOMOS CO., LTD., Hwaseong-si Gyeonggi-do (KR)

(21) Appl. No.: 19/536,879

(22) Filed: Feb. 11, 2026

(30) Foreign Application Priority Data
Mar. 6, 2025 (KR) 10-2025-0029152

(51) Int. Cl. B60N 2/75; A47C 1/03

(52) U.S. Cl. CPC B60N 2/77; A47C 1/03; B60N 2/753

(57) ABSTRACT

Provided are a pop-up type holder, and an armrest and a console assembly both including the pop-up type holder. The pop-up type holder includes a housing, a holder moving up and down between a first position at which the holder is stored in the housing and a second position at which the holder protrudes from the housing, a base plate having a shape corresponding to an opening of the holder, moving up and down within the holder in an opposite direction with respect to the up-and-down movement of the holder, and supporting an item in the holder, and a rotation link interlocking up-and-down movements of the holder and the base plate, and, when a load is applied to the base plate, the rotation link is rotated such that the holder moves upward from the first position to the second position.

### CROSS-REFERENCE TO RELATED APPLICATION

This application claims priority to Korean Patent Application No. 10-2025-0029152 filed on March 6, 2025, the entire content of which is incorporated by reference.

### BACKGROUND

### 1. Field

The disclosure relates to a pop-up type holder, and an armrest and a console assembly both including the pop-up type holder. More particularly, the disclosure relates to a console assembly provided on a moving object such as a vehicle, an armrest mounted on the console assembly, and a pop-up type holder provided on the armrest, for the convenience of the driver and passengers.

### 2. Description of the Related Art

Console assemblies of moving objects such as vehicles are modular structures installed between driver's seats and front passenger seats or in specific parts inside the vehicles so that drivers and passengers may conveniently use various functions. Console assemblies may include cup holders, storage bins for personal items, and spaces equipped with universal serial buses (USBs) or power ports, or armrests that allow drivers to comfortably rest their arms to reduce the driver's fatigue.

As purpose-built mobility and autonomous vehicles become more widespread in the mobility industry, there is a growing demand to utilize the interior spaces of vehicles as mobile offices or relaxation spaces rather than simple transportation means. Accordingly, consumers are demanding a table function of enjoying meals or drinks in vehicles and simultaneously perform simple tasks. However, the console assembly of the related art has a limited table function or low space utilization, which made it difficult to flexibly respond to various postures and uses.

### SUMMARY

Provided are a pop-up type holder that is stored inside a housing and pops up with a simple operation when needed to hold a container or a cup, and an armrest and a console assembly both including the pop-up type holder.

Provided are an armrest that is rotated to implement a table on which items may be conveniently placed and used, and a console assembly including the armrest.

The solutions of the disclosure are not limited to the above-mentioned contents, and other technical problems not mentioned will be clearly understood by one of ordinary skill in the art from the following description.

According to an embodiment of the disclosure, a pop-up type holder includes a housing, a holder moving up and down between a first position at which the holder is stored in the housing and a second position at which the holder protrudes from the housing, a base plate having a shape corresponding to an opening of the holder, moving up and down within the holder in an opposite direction with respect to the up-and-down movement of the holder, and supporting an item in the holder, and a rotation link interlocking up-and-down movements of the holder and the base plate, and, when a load is applied to the base plate, the rotation link is rotated such that the holder moves upward from the first position to the second position.

A pair of first link connection grooves may be provided on opposite sides of a lower surface of the holder, a pair of second link connection grooves extending in a horizontal direction may be provided in a lower portion of the base plate, and the rotation link may be provided as a pair, each one end of the rotation links moving along the first link connection groove and each other end of the rotation links moving along the second link connection groove such that the rotation links rotate.

The first link connection groove may include a key groove having a bent shape, and when the holder moves from the first position to the second position, one end of the rotation link may be inserted into the key groove such that the holder is fixed at the second position.

When a user lifts the holder upward at the second position, the holder may be restored to the first position as the one end of the rotation link is disengaged from the key groove.

A first spring may be provided in the housing, the first spring provided between a lower surface of an upper portion of the housing and a lower end of the holder, and elastically pressing the holder downward at the second position.

A second spring may be provided in the housing, the second spring elastically pressing the base plate upward at the second position.

According to another embodiment of the disclosure, an armrest including a pop-up type holder includes an armrest housing, a holder moving up and down between a first position at which the holder is stored in the armrest housing and a second position at which the holder protrudes from the armrest housing, a base plate having a shape corresponding to an opening of the holder, moving up and down within the holder in an opposite direction with respect to the up-and-down movement of the holder, and supporting an item in the holder, and a rotation link interlocking up-and-down movements of the holder and the base plate, wherein when a load is applied to the base plate, the rotation link is rotated such that the holder moves upward from the first position to the second position.

According to another embodiment of the disclosure, a console assembly provided on a moving object includes a console body provided on the moving object and storing items, and an armrest with one end rotatably provided on an upper portion of the console body, wherein the armrest includes an armrest housing, a holder moving up and down between a first position at which the holder is stored in the armrest housing and a second position at which the holder protrudes from the armrest housing, a base plate having a shape corresponding to an opening of the holder, moving up and down within the holder in an opposite direction with respect to the up-and-down movement of the holder, and supporting an item in the holder, and a rotation link interlocking up-and-down movements of the holder and the base plate, wherein when a load is applied to the base plate, the rotation link is rotated such that the holder moves upward from the first position to the second position.

### BRIEF DESCRIPTION OF THE DRAWINGS

FIG. 1 is a diagram illustrating a first state of a console assembly according to an embodiment of the disclosure;

FIG. 2 is a diagram illustrating a second state of a console assembly according to an embodiment of the disclosure;

FIG. 3 is a diagram illustrating a third state of a console assembly according to an embodiment of the disclosure;

FIG. 4 is an exploded perspective view of an armrest in a second state according to an embodiment of the disclosure;

FIG. 5 is an exploded perspective view of a holder assembly of FIG. 4;

FIG. 6 is an exploded front view of the holder assembly of FIG. 4;

FIG. 7 is a diagram illustrating a first link connection groove of a holder of FIG. 6;

FIG. 8 is a cross-sectional view of an armrest in which a holder is at a first position;

FIG. 9 is a cross-sectional view of an armrest in which a holder is at a second position; and

FIG. 10 is an enlarged view of a region A of FIG. 9 illustrating a holder lifted to a second position.

### DETAILED DESCRIPTION

Hereinafter, embodiments of the disclosure will be described in detail with reference to the accompanying drawings so that one of ordinary skill in the art may easily implement the disclosure. The disclosure may, however, be embodied in many different forms and should not be construed as being limited to the embodiments set forth herein. For clarity, portions that are not relevant to the description of the disclosure are omitted.

The terms used in the specification are merely used to describe particular embodiments of the disclosure, and are not intended to limit the disclosure. An expression used in the singular encompasses the expression of the plural, unless it has a clearly different meaning in the context.

In the specification, it is to be understood that the terms such as "including", "having," and "comprising" are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

In addition, the components shown in the embodiments of the disclosure are shown independently to represent different characteristic functions, and do not mean that each component includes separate hardware or one software unit. That is, each component is described by listing each component for convenience of description, and at least two of the components may be combined to form one component, or one component may be divided into a plurality of components to perform a function. The integrated and separated embodiments of each of these components are also included within the scope of the disclosure without departing from the spirit of the disclosure.

In addition, embodiments below are provided so that the disclosure will be thorough and complete, and will fully convey the concept of the disclosure to one of ordinary skill in the art. In the drawings, sizes and thicknesses of components may be exaggerated for clarity.

Hereinafter, the disclosure will be described in detail with reference to the attached drawings.

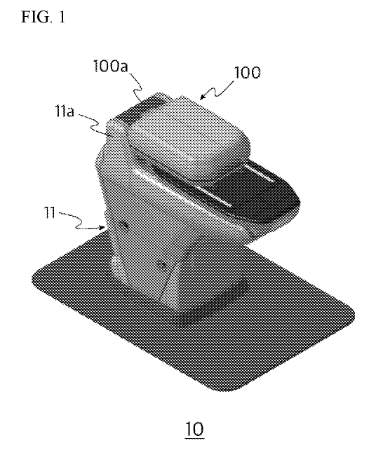

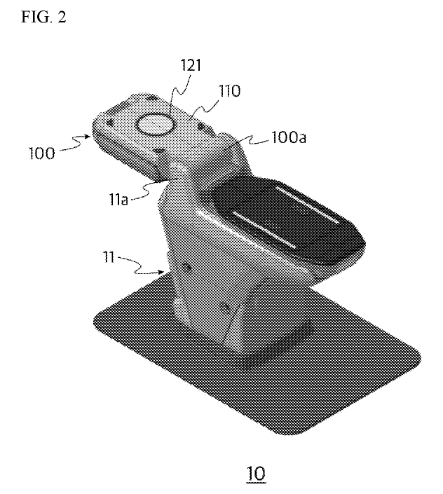

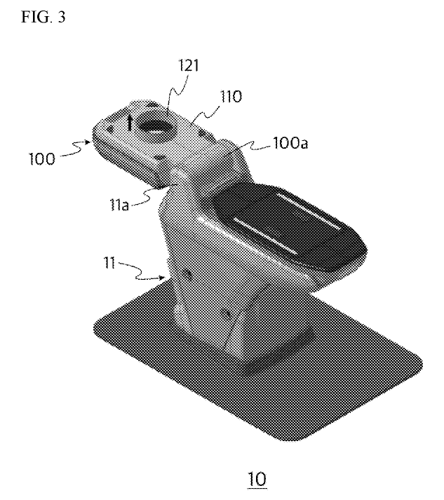

FIG. 1 is a diagram illustrating a first state of a console assembly 10 according to an embodiment of the disclosure. FIG. 2 is a diagram illustrating a second state of the console assembly 10 according to an embodiment of the disclosure. FIG. 3 is a diagram illustrating a third state of the console assembly 10 according to an embodiment of the disclosure.

Referring to FIGS. 1 to 3, the console assembly 10 according to an embodiment of the disclosure is installed on a moving object such as a car or an airplane and provided for use convenience by passengers, and may include a console body 11 and an armrest 100. The armrest 100 of the console assembly 10 according to an embodiment of the disclosure may be usable as an armrest or a table according to a rotational state of the armrest 100, and one end 100a thereof may be rotatably provided on an upper portion 11a of the console body 11.

In an embodiment, the armrest 100 may be rotated 180 degrees from the first state shown in FIG. 1 to be changed to the second state shown in FIG. 2. The armrest 100 may be used as an armrest in the first state, and may be used as a table in the second state. In this case, the armrest 100 may also be used as a table of a passenger seated in the rear seat. The armrest 100 may be rotated back to the first state from the second state.

In addition, the armrest 100 may be in the third state in which a holder 121 protrudes to the outside of an armrest housing 110, as shown in FIG. 3, from the second state. The holder 121 may move up and down between the first position at which the holder 121 is stored inside the armrest housing 110 and the second position at which the holder 121 protrudes outside the armrest housing 110 and may change the armrest 100 from the second state to the third state or from the third state to the second state.

As described above, the armrest 100 according to an embodiment of the disclosure may be changed to the first state to the third state to respond to various demands of passengers. The first state is an armrest usage state in which the armrest 100 remains in its initial arrangement mounted on an upper portion of the console body 11, and a user may comfortably rest the user’s arms in the first state. The second state is a state in which the armrest 100 is used as a table, and by rotating the armrest 100 by about 180 degrees, a lower cover surface of the armrest 100 may be deployed horizontally or quasi-horizontally toward a passenger and used as a small table. In the second state, drinks or light meals, or laptops, tablet PCs, etc. may be placed on the armrest 100 and used, thereby maximizing space utilization in a vehicle and increasing work convenience. The third state is a state in which the holder 121 of the armrest 100 is used, for example, as a cup holder, and when the armrest 100 is in the second state, the holder 121 may pop up from the inside of the armrest housing 110 and protrude to the outside. In this state, the user may easily place a cup or a beverage container, and after use, the holder 121 may be stored back into the armrest housing 110 to keep a table top concise. Accordingly, a function of stably placing the beverage even when the armrest 100 is used as a table is additionally provided, and thus, convenience in the vehicle and space utilization may be further increased.

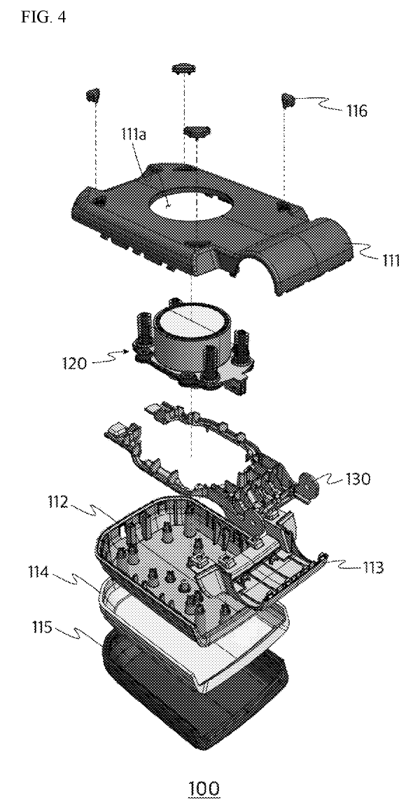

FIG. 4 is an exploded perspective view of the armrest 100 in a second state according to an embodiment of the disclosure.

Referring to FIG. 4, the armrest 100 according to an embodiment of the disclosure may include the armrest housing 110, a holder assembly 120 disposed inside the armrest housing 110, and a hinge bracket 130 for rotatably supporting the armrest 100.

The armrest housing 110 may include a housing lower cover 111, a housing core 112, and a housing hinge cover 113. The housing lower cover 111 is for forming one surface of the armrest 100 and protecting and supporting internal components, and may be used as a table as shown in FIG. 2. An opening 111a may be formed in the housing lower cover 111 for the up-and-down movement of the holder 121, and the holder assembly 120 including the holder 121 may be provided in the armrest housing 110. The housing core 112 may form an inner frame of the armrest 100, and may fix or support other components of the armrest 100, such as the holder assembly 120 and the hinge bracket 130. A plurality of ribs or supporters may be provided inside the housing core 112, thereby ensuring assembly rigidity and mitigating impact. The housing hinge cover 113 may be provided to protect a rotation axis of the hinge bracket 130 from the outside and to process a coupled part for smooth finish.

According to an embodiment, the armrest housing 110 may further include a housing foam 114, a housing skin 115, or a housing damper 116. The housing foam 114 is for buffering a part where the user's arm touches when the armrest 100 is used as an armrest in the first state shown in FIG. 1, and may be formed on one surface of the housing core 112. The housing foam 114 may include a material such as foam or sponge that serves as a buffer so that the user may feel comfortable when resting the user’s arm or hand thereon. The housing skin 115 serves as a final finishing material exposed to the outside, and may include various materials such as artificial leather, cloth, and synthetic resin. The housing damper 116 is for absorbing impact that may occur when the armrest 100 is changed from the second state to the first state, and may be provided in plural in the lower housing cover 111.

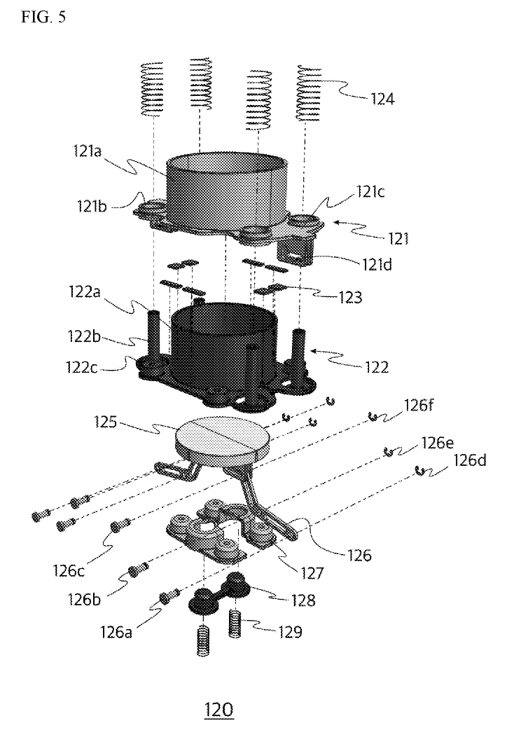

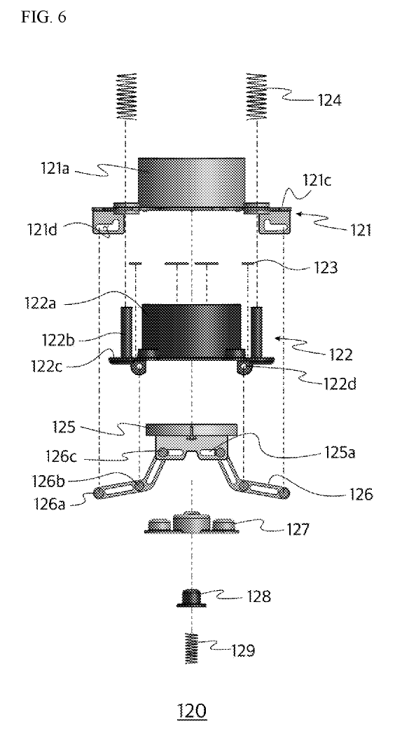

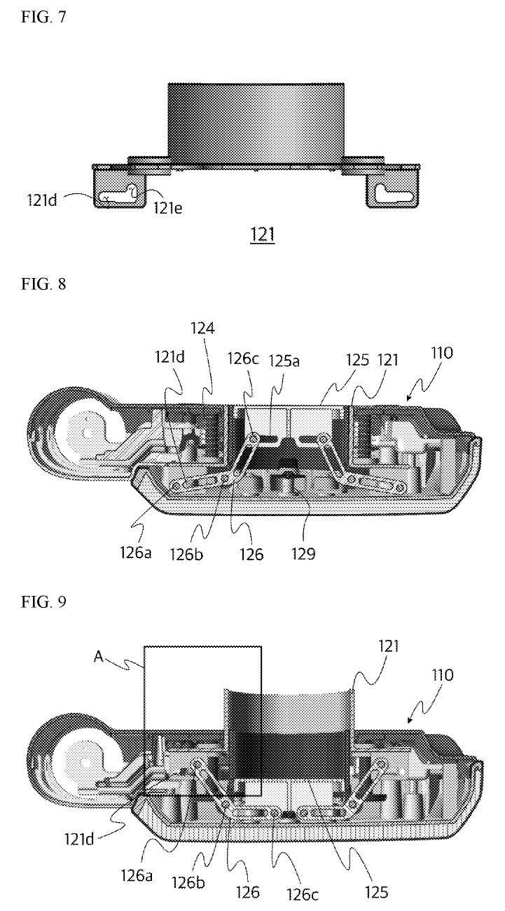

FIG. 5 is an exploded perspective view of the holder assembly 120 of FIG. 4. FIG. 6 is an exploded front view of the holder assembly 120 of FIG. 4. FIG. 7 is a diagram illustrating a first link connection groove 121d of the holder 121 of FIG. 6.

Referring to FIGS. 5 to 7, the holder assembly 120 according to an embodiment of the disclosure is a module that is disposed inside the armrest housing 110 and configured to allow the holder 121 to protrude outside the armrest housing 110, and may include the holder 121, a fixing plate 122, a damper 123, a first spring 124, a base plate 125, a rotation link 126, a second spring bracket 127, a second spring plate 128, and a second spring 129.

The holder 121 is configured to move up and down to be stored in or protrude from the armrest housing 110 to hold a cup or an item, and may include a flange 121c in which a cylindrical body 121a and a plurality of holes 121b are formed. A pair of first link connection grooves 121d for coupling with a pair of rotation links 126 to move the holder 121 may be formed on opposite sides of a lower surface of the flange 121c. In the embodiment, the holder 121 is described as having the cylindrical body 121a as an example, but is not limited thereto, and may also be a polygonal or arbitrary through shape.

The fixing plate 122 is for movably supporting the holder 121 and accommodating the holder 121, and may be fastened and fixed to the housing core 112. The fixing plate 122 may include a cylindrical body 122a and a flange 122c in which a plurality of bosses 122b are formed so as to correspond to the holder 121. A pair of link coupling grooves 122d for coupling with rotation axes of the pair of rotation links 126 may be formed in opposite sides of a lower surface of the flange 122c of the fixing plate 122. A plurality of dampers 123 configured to mitigate impact that may occur in the downward movement of the holder 121 may be provided on an upper surface of the flange 122c of the fixing plate 122.

The holder 121 may be stacked on the fixing plate 122. The body 122a of the fixing plate 122 may be inserted into and stored in the body 121a of the holder 121, and the boss 122b of the fixing plate 122 may be inserted into the hole 121b of the holder 121. The first spring 124 may be provided between a lower surface of an upper portion of the armrest housing 110 (corresponding to the lower cover 111 in the case of the armrest housing 110) and a lower end of the holder 121. More specifically, the first spring 124 may be provided between the flange 121c of the holder 121 and the lower surface of the upper portion of the armrest housing 110. In an embodiment, four first springs 124 may be provided along the circumference of the holder 121. The first spring 124 may elastically press the holder 121 downward when the holder 121 is at the second position. The boss 122b may prevent buckling of the first spring 124 when the first spring 124 is compressed or decompressed.

The base plate 125 is a support inserted into the body 121a of the holder 121 and configured to support a cup or an item from below, and may slide and move up and down along the body 121a of the holder 121. Specifically, the base plate 125 may have a shape corresponding to an opening of the holder 121, move up and down within the holder 121 in the opposite direction with respect to the up-and-down movement of the holder 121, and support an item in the holder 121. A pair of second link connection grooves 125a may be formed in a lower portion of the base plate 125 so that ends of the pair of rotation links 126 may horizontally move and be rotatably coupled. In addition, a second spring 129 may be provided in the housing 110 to elastically press upward the base plate 125 that has moved downward when the holder 121 is at the second position. More specifically, the second spring plate 128 may be supported on an upper portion of the second spring 129, and may press the base plate 125 upward at the second position. In addition, the second spring bracket 127 may constrict the upward movement distance of the second spring plate 128 so that the second spring plate 128 moves upward only by a predetermined height.

The pair of rotation links 126 are for interlocking the up-and-down linear movements of the holder 121 and the base plate 125. To this end, the pair of first link connection grooves 121d extending in a horizontal direction may be provided on opposite sides of a lower surface of the holder 121, and the pair of second link connection grooves 125a extending in the horizontal direction may be provided in the lower portion of the base plate 125. The rotation links 126 may be provided in a pair on the left and right with each one end moving along the first link connection groove 121d, and each other end moving along the second link connection groove 125a, and rotate. More specifically, one end of the rotation link 126 may be coupled to the first link connection groove 121d of the holder 121, each other end may be coupled to the second link connection groove 125a of the base plate 125, and each rotation axis may be coupled to the link connection groove 122d of the fixing plate 122. Coupling between the respective rotation links 126 and the respective connection grooves 122d may be performed using keys 126a, 126b, 126c and rings 126d, 126e, and 126f. The key 126b coupled to the link connection groove 122d may serve as a pivot axis of the rotation link 126.

The first link connection groove 121d of the holder 121 and the second link connection groove 125a of the base plate 125 may extend in the horizontal direction, and when the pair of rotation links 126 each rotate clockwise or counterclockwise around the pivot axis 126b, the keys 126a and 126c respectively coupled thereto may horizontally slidably move in a longitudinal direction of the first link connection groove 121d or the second link connection groove 125a. The keys 126a and 126c coupled to the first link connection groove 121d or the second link connection groove 125a may naturally move in accordance with the rotation trajectory of the rotation link 126, and thus, a relative position change between the holder 121 and the base plate 125 may be made smoothly, and operation stability may be improved.

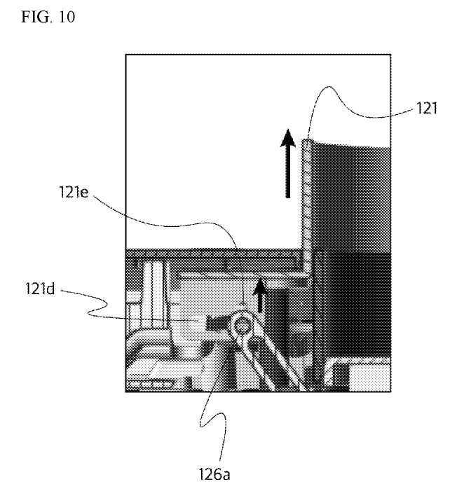

The first link connection groove 121d may have a shape extending horizontally and have a curved guide structure further including a key groove 121e bent at one end and extending upward. The key groove 121e is a portion in which the key 126a of the rotation link 126 is finally seated while the holder 121 moves up and down from the first position to the second position. The key 126a may move in the horizontal direction along the first link connection groove 121d and then move upward to be inserted into the key groove 121e, and thus, the holder 121 may be stably fixed at the second position. That is, when the key 126a is coupled to the key groove 121e, the holder 121 may be maintained not to move arbitrarily. Referring to FIG. 10, at the second position, the user may further lift the holder 121 or the key 126a may be separated downward from the key groove 121e so that the holder 121 may return to the first position again. Accordingly, the holder 121 may be easily fixed in a pop-up state and released from the pop-up state.

The second spring 129 may be provided below the second spring plate 128 to elastically press upward the base plate 125 that has moved downward. When the base plate 125 moves up and down in conjunction with the movement of the holder 121 and the rotation link 126, the second spring 129 may assist the up-and-down operation of the base plate 125 or maintain the supporting force with respect to the base plate 125.

FIG. 8 is a cross-sectional view of an armrest in which the holder 121 is at a first position. FIG. 9 is a cross-sectional view of the armrest in which the holder 121 is at a second position. FIG. 10 is an enlarged view of a region A of FIG. 9 illustrating the holder 121 lifted to the second position.

A process of operating the holder 121 according to an embodiment of the disclosure will be described with reference to FIGS. 8 to 10. The holder 121 disposed in the armrest housing 110 may be stored inside the armrest housing 110 at the first position and protrude from the armrest housing 110 at the second position so that a user may access the holder 121.

For example, when the user places a cup containing a beverage on the base plate 125, the base plate 125 may move downward due to the weight of the cup, and the rotation link 126 may be rotated around the pivot axis 126b. In this regard, as the other end of each of the pair of rotation links 126 moves and pivots in a horizontal direction along the second link connection groove 125a of the base plate 125, each of the rotation links 126 in a curved shape rotates clockwise and counterclockwise around the pivot axis 126b. As the rotation link 126 rotates, one end of the rotation link 126 slidably moves in the horizontal direction in a longitudinal direction of the first link connection groove 121d of the holder 121. Through sliding movement, the holder 121 may move upward from the first position to the second position in the opposite direction to the base plate 125, and may perform a pop-up operation to the outside of the armrest housing 110.

When the holder 121 sufficiently moves upward, the key 126a coupled to the first link connection groove 121d of the holder 121 may be inserted into the key groove 121e. In this regard, while the key 126a is fastened to the key groove 121e, the holder 121 is fixed so as not to move downward arbitrarily, and thus, the user may use the pop-up type holder 121 stably. In addition, the user may easily use the cup placed on the base plate 125 while the holder 121 moves upward to the second position, and the holder 121 may be sufficiently exposed outside the armrest housing 110, and thus, convenience may be improved when placing or drinking.

Thereafter, when the user removes the cup placed on the base plate 125 and lifts the holder 121 upward to return the holder 121 to a storage state again, as the key 126a is disengaged from the key groove 121e, a fixed state of the holder 121 may be released. The moment the fixing of the holder 121 is released, the holder 121 may move downward to the inside of the armrest housing 110 and return to the first position due to the reverse movements of the rotation link 126, and the first spring 124 and the second spring 129 that assist in returning the holder 121 and the base plate 125 to their original positions, and the base plate 125 may also return upward again. Through this process, pop-up and return of the holder 121 may be performed only by a simple operation, and the key groove 121e may provide a stable use environment by fixing the holder 121.

The first spring 124 and the second spring 129 may assist in pop-up operations of the holder 121 and the base plate 125. The first springs 124 provided in plural along the circumference of the holder 121 may evenly distribute the load of the base plate 125 when the base plate 125 is moved upward or pressed downward to prevent the base plate 125 from wobbling to one side or moving unevenly. Accordingly, the first spring 124 may improve the operational feel when the user places or presses a cup or the like on the base plate 125.

The second spring 129 may serve to amplify an initial moment acting on the base plate 125 and the rotation link 126. When the base plate 125 moves downward due to the weight of the cup or the user's pressing, the second spring 129 may be compressed together to accumulate restoring forces, and then, when the user lifts the holder 121 upward so that the key 126a is disengaged from the key groove 121e, and fixing of the holder 121 is released, the second spring 129 may restore the holder 121 upward with an elastic force. When there is no second spring 129, even though the holder 121 is lifted upward, the base plate 125 may not sufficiently move upward due to insufficient moment applied to the rotation link 126, and the holder 121 may not also return to its original position at a desired speed or height. By mounting the second spring 129 in the lower portion of the base plate 125, the initial moment may be increased so that the holder 121 may easily and quickly pop up after the fixing is released.

The pop-up type holder of the disclosure, and the armrest and the console assembly both including the pop-up type holder, are designed to rotate to a certain angle around a rotation axis, thereby flexibly selecting an armrest use and a table use according to a user environment.

In addition, the holder is stored inside the housing and pops up with a simple operation when needed to hold a container or a cup, thereby achieving efficient utilization and aesthetics of the boarding space at the same time.

In addition, because the holder and the base plate move upward or downward in the opposite direction with respect to the rotation link, when the weight of the cup is transferred to the base plate, the holder naturally protrudes upward, and after holding the cup, a fixed state of the holder is formed by the key groove, thereby ensuring stable usability.

In addition, after use, the holder returns to its original position through a simple operation of lifting or pulling the holder, thereby easily operating the holder with one hand without a separate button or complicated lever.

In addition, even when the holder fully pops up to the outside, the spring and the link mutually restrain and reduce shaking, thereby stably supporting the cup.

As described above, the pop-up type holder of the disclosure, and the armrest and the console assembly both including the pop-up type holder may satisfy space utilization and aesthetics, ease of operation, and stability, and thus, they may be usefully applied to particularly future transportation such as autonomous driving-based mobility, and widely used even in armrests or console modules of various vehicles including general vehicles.

The embodiments described herein are intended to illustrate the armrest and the console assembly, and the disclosure is not necessarily limited to these components. For example, the pop-up type holder proposed in the disclosure is not provided on the armrest or may be implemented as a separate structure independent of the console assembly, and also be applicable to internal spaces of various moving objects such as ships, aircraft, and rail vehicles or applications such as fixed furniture or display stands. Therefore, the technical spirit of the disclosure is not limited to the configurations or uses of the described embodiments, and many modifications and variations are possible within the equivalent scope.

In the pop-up type holder according to an embodiment of the disclosure, and the armrest and the console assembly both including the pop-up type holder, the holder may be stored inside the housing and pop up with a simple operation when needed to hold a container or a cup.

In addition, the armrest may be rotated to implement a table on which items may be conveniently placed and used.

The effects of the disclosure are not limited to the above-mentioned effects, and other effects not mentioned will be clearly understood by one of ordinary skill in the art from the description provided above.

Although the disclosure has been described with reference to the embodiment shown in the drawings, this is merely exemplary and will be understood by one of ordinary skill in the art that various modifications and equivalent other embodiments are possible. Therefore, the true technical protection scope of the disclosure will be defined by the technical spirit of the appended claims.

What is claimed is:

1. A pop-up type holder comprising:
a housing;
a holder moving up and down between a first position at which the holder is stored in the housing and a second position at which the holder protrudes from the housing;
a base plate having a shape corresponding to an opening of the holder, moving up and down within the holder in an opposite direction with respect to up-and-down movement of the holder, and supporting an item in the holder; and
a rotation link interlocking up-and-down movements of the holder and the base plate,
wherein when a load is applied to the base plate, the rotation link is rotated such that the holder moves upward from the first position to the second position.

2. The pop-up type holder of claim 1, wherein a pair of first link connection grooves are provided on opposite sides of a lower surface of the holder,
a pair of second link connection grooves extending in a horizontal direction are provided in a lower portion of the base plate, and
the rotation link is provided as a pair, each one end of the rotation links moving along the first link connection groove and each other end of the rotation links moving along the second link connection groove such that the rotation links rotate.

3. The pop-up type holder of claim 2, wherein the first link connection groove includes a key groove having a bent shape, and
when the holder moves from the first position to the second position, one end of the rotation link is inserted into the key groove such that the holder is fixed at the second position.

4. The pop-up type holder of claim 3, wherein when a user lifts the holder upward at the second position, the holder is restored to the first position as the one end of the rotation link is disengaged from the key groove.

5. The pop-up type holder of claim 1, wherein a first spring is provided in the housing, the first spring provided between a lower surface of an upper portion of the housing and a lower end of the holder, and elastically pressing the holder downward at the second position.

6. The pop-up type holder of claim 5, wherein a second spring is provided in the housing, the second spring elastically pressing the base plate upward at the second position.

7. An armrest comprising a pop-up type holder, the armrest comprising:
an armrest housing;
a holder moving up and down between a first position at which the holder is stored in the armrest housing and a second position at which the holder protrudes from the armrest housing;
a base plate having a shape corresponding to an opening of the holder, moving up and down within the holder in an opposite direction with respect to up-and-down movement of the holder, and supporting an item in the holder; and
a rotation link interlocking up-and-down movements of the holder and the base plate,
wherein when a load is applied to the base plate, the rotation link is rotated such that the holder moves upward from the first position to the second position.

8. A console assembly provided on a moving object, the console assembly comprising:
a console body provided on the moving object and storing items; and
an armrest with one end rotatably provided on an upper portion of the console body,
wherein the armrest comprises:
an armrest housing;
a holder moving up and down between a first position at which the holder is stored in the armrest housing and a second position at which the holder protrudes from the armrest housing;
a base plate having a shape corresponding to an opening of the holder, moving up and down within the holder in an opposite direction with respect to up-and-down movement of the holder, and supporting an item in the holder; and
a rotation link interlocking up-and-down movements of the holder and the base plate, and
when a load is applied to the base plate, the rotation link is rotated such that the holder moves upward from the first position to the second position.
